(19) United States
(12) Patent Application Publication
(10) Pub. No.: US 2024/0198797 A1
(43) Pub. Date: Jun. 20, 2024

(54) REMOTELY CONTROLLED RECREATIONAL VEHICLE FOR TOWING PERSONNEL

(71) Applicant: John WEISS, Colorado Springs, CO (US)

(72) Inventor: John WEISS, Colorado Springs, CO (US)

(21) Appl. No.: 18/533,071

(22) Filed: Dec. 7, 2023

Related U.S. Application Data
(60) Provisional application No. 63/386,736, filed on Dec. 9, 2022.

(51) Int. Cl. B60K 26/04; B60K 26/02; B62D 11/04; B62D 55/10

(52) U.S. Cl. CPC B60K 26/04; B60K 26/02; B62D 11/04; B62D 55/10; B60K 2026/046

(57) ABSTRACT

A vehicle apparatus typically for use on snow and similar ground terrain for the use of towing personnel from a first location to a second location wherein the user typically wears skis, snowboard, or other alpine or Nordic devices and is towed along the snow by a retractable tether which is optionally interconnected to a remote-controller or directly to the user.

### CROSS-REFERENCE TO RELATED APPLICATION

This application claims the benefit of U.S. Provisional Patent Application No. 63/386,736 entitled “REMOTELY CONTROLLED RECREATIONAL VEHICLE FOR TOWING PERSONNEL” filed on Dec. 9, 2022, the entire contents of which is incorporated herein by reference in its entirety for all purposes.

### FIELD OF THE INVENTION

The present disclosure is directed to a recreational vehicle which is configured to be remotely controlled for the purposes of towing a user behind, or allowing a user to remotely pilot the vehicle to place the vehicle at a distance from the user as desired.

### BACKGROUND OF THE INVENTION

The use of motorized transportation, powered by battery or fossil fuels, provides recreationists opportunity to explore further into the wilderness and areas outside of the reaches of established recreation areas, such as ski resorts. The use of motorized transportation enables individuals to venture into terrain untracked and undisturbed by the general population, which is otherwise inaccessible through ordinary means.

The use of motorized transportation, in winter terrains for instance, commonly involves the use of a snowmobile. Snowmobiles, also commonly known as “power sleds” are recreational vehicles typically comprising a motor driven track configured to engage with the snow in the rearward aspect of the vehicle, and two skis in the forward aspect of the vehicle to provide sliding support which is steerable to the left and right to allow directional control of the snowmobile.

In certain situations, such as backcountry skiing or snowboarding, a skier may want to transport themselves to a remote skiing location with their snowmobile to enjoy a particular hill. The use of the snowmobile requires relatively minimal effort for cross-country transportation and climbing in comparison to alpine touring or other human powered means such as walking or snowshoeing. At this point the skier has a few options, each of which presents a particular drawback.

The skier could leave the snowmobile at the top of the hill and rely on human powered means to climb the hill following their descent to retrieve the snowmobile. Alternatively, the skier can leave the snowmobile at the bottom of the hill, and ascend the hill for their planned descent. However, either of these strategies rely upon human power to ascend the hill which involves extended amounts of time and requires the skier to transition between climbing modes and descending modes with specialized skiing equipment.

Alternatively, the skier can put the snowmobile in neutral to disengage the motor from the driven track and push the snowmobile down the hill in a strategy commonly referred to as “ghost riding”. Ghost riding the snowmobile down a hill allows the skier to ski down to retrieve their snowmobile. This practice while effective, requires the skier to remove their skis each time to board the snowmobile to ascend to the top of the next hill and reaffix their skis to their feet when descending. Furthermore, when ghost riding a snowmobile, the skier is unable to direct or control the snowmobile in relation to obstacles such as terrain depressions, trees, rocks, and other obstacles which may result in the snowmobile being damaged, stuck, or in a location which may put the skier in danger of an avalanche when they go to retrieve the snowmobile.

Each of these scenarios results in a loss of time, potential damage to equipment, or a potentially dangerous situation for the skier wherein the skier can be injured or killed. Thus, there is an identified need for a vehicle which a skier can use to transport themselves to a backcountry location, and then remotely pilot the vehicle to a safe location for retrieval and further use.

Furthermore, the access to ski resorts can be limiting as such resources are limited by geographic location as well as limited by financial means. With the increasing cost of ski resorts, many wish to enjoy skiing or snowboarding without the necessity of paying exorbitant costs of a lift ticket. Activities such as skijoring typically surround a skier being towed behind a motor vehicle, horse, or other means of transportation which is piloted by another individual while not necessitating the need for a lift or even a slope. Thus, there is a further identified need to provide an alternative manner of transporting or towing a skier or snowboarding in winter terrain or otherwise, in a manner that allows the freedom to traverse winter terrain at speeds beyond the means provided by human powered transportation while not requiring a second individual, ski lifts, or sloped terrain.

### SUMMARY OF THE INVENTION

It is an aspect of certain embodiments of the present disclosure to provide a vehicle for overland transportation in winter terrain wherein a skier can use the vehicle to tow themselves to a first location, and then remotely pilot or remotely control the vehicle to a second location. Certain embodiments of the present disclosure comprise a tracked vehicle configured for transportation over winter terrain wherein the vehicle comprises a remote-control unit configured to interconnect with the vehicle. In a towing configuration, the remote-control unit is interconnected with the vehicle with a tether, thereby allowing the user to be towed by the vehicle while simultaneously remotely piloting the vehicle. In a remote piloting configuration, the remote-control unit is disconnected from the vehicle, wherein the remote-control unit is in wireless communication with the vehicle to allow the remote piloting of the vehicle at a distance.

A benefit of remotely piloting the system includes allowing the user to navigate obstacles and terrain features that may cause damage to the vehicle or result in the vehicle getting stuck. Furthermore, the ability to remotely pilot the vehicle allows a skier to direct the vehicle to a precise location which allows a user to ensure the vehicle does not end up in a location having increased avalanche risk such as a terrain trap or come to rest in a location which requires a skier to stop earlier than desired or to traverse beyond a desired end-location.

Furthermore, in certain embodiments the remote-control unit is interconnected with the handlebars of the vehicle. Thus, the user can control the vehicle as they grasp the handlebars in a towing configuration or control the unit in a remote piloting configuration wherein, they grasp the handlebars, but the handlebars are not physically interconnected with the vehicle. In certain embodiments, the vehicle apparatus can be fitted with a seat interconnected with the frame to allow a user to optionally sit on the vehicle apparatus. Further accessories such as a litter for carrying injured personnel, cargo containers, and otherwise can be fitted to the vehicle apparatus within the spirit and scope of the present disclosure.

Traditional snowmobiles are often too large to transport with a standard Sports Utility Vehicle (SUV) or pickup truck. Modern snowmobiles are often between 9.5-11.25 feet long, which is too long to properly fit in the bed of a pickup truck. Transporting a snowmobile in the bed of a pickup truck typically requires the tailgate to be left down as a standard pickup truck bed has a maximum of 8 feet. It is an aspect of certain embodiments of the present disclosure to provide increased transportability of a vehicle for overland transportation in winter. Embodiments of the present disclosure are easily transportable within a large SUV or within the bed envelope of a standard pickup truck without requiring the tailgate to be left down. For instance, certain embodiments of the present disclosure comprise an overall length of 62 inches, a width of 54 inches, and a height of 32 inches.

Certain embodiments of the present disclosure comprise a tracked vehicle for overland travel over winter terrain comprising two driven tracks. In certain embodiments the two drive tracks are driven at substantially the same rate and wherein the steering of the vehicle comprises the pivoting of the driven tracks toward a first lateral side or a second lateral side as desired. In certain embodiments, snow-flaps, or mud-flaps are optionally interconnected to the vehicle to prevent the throwing of debris at a user in tow.

Alternatively, the steering of the vehicle in certain embodiments involves the independent modulation of the individual driven tracks independently. For instance, the rotation of the first driven track at a rate which is lower than that of the second driven track, results in the vehicle to rotate or steer toward the first driven track. Similarly, the rotation of the second driven track at a rate which is lower than that of the first driven track, results in the vehicle to rotate or steer toward the second driven track. Furthermore, the tracks can be used in opposing directions—one track in a forward direction and a second track in a reverse direction—to negotiate tighter turns.

These and other advantages will be apparent from the disclosure of the disclosures contained herein. The above-described embodiments, objectives, and configurations are neither complete nor exhaustive. As will be appreciated, other embodiments of the disclosure are possible using, alone or in combination, one or more of the features set forth above or described in detail below. Further, this Summary is neither intended nor should it be construed as being representative of the full extent and scope of the present disclosure. The present disclosure is set forth in various levels of detail in this Summary, as well as in the attached drawings and the detailed description below, and no limitation as to the scope of the present disclosure is intended to either the inclusion or non-inclusion of elements, components, etc. in this Summary. Additional aspects of the present disclosure will become more readily apparent from the detailed description, particularly when taken together with the drawings, and the claims provided herein.

### BRIEF DESCRIPTION OF THE DRAWINGS

FIG. 1A—A side view of certain embodiments comprising a remoted controlled tracked vehicle

FIG. 1B—A perspective view of certain embodiments comprising a remote-controlled tracked vehicle

FIG. 1C—An alternate perspective view of certain embodiments comprising a remote-controlled tracked vehicle

FIG. 2—A front view of certain embodiments comprising a remote-controlled tracked vehicle

FIG. 3A—A perspective view of certain embodiments comprising a remote-controlled tracked vehicle

FIG. 3B—A detail view of the embodiment shown in FIG. 3A

FIG. 4A—An overhead view of certain embodiments comprising a remote-controlled tracked vehicle

FIG. 4B—A detail view of the embodiment shown in FIG. 4A

FIG. 5A—A perspective view of certain embodiments comprising a remote-controlled tracked vehicle

FIG. 5B—A detail view of the embodiment shown in FIG. 5A

FIG. 6—A side view of certain embodiments comprising a remote-controlled tracked vehicle

FIG. 7A—A top view of certain embodiments of the present disclosure comprising a remote-controller

FIG. 7B—A front view of certain embodiments of the present disclosure comprising a remote-controller

FIG. 8—A diagrammatic view of a system of certain embodiments comprising a remotely controlled tracked vehicle and a remote-controller

FIG. 9—A representation of a throttle assembly comprising a progressive spring-rate modulated throttle

### DETAILED DESCRIPTION OF VARIOUS EMBODIMENTS

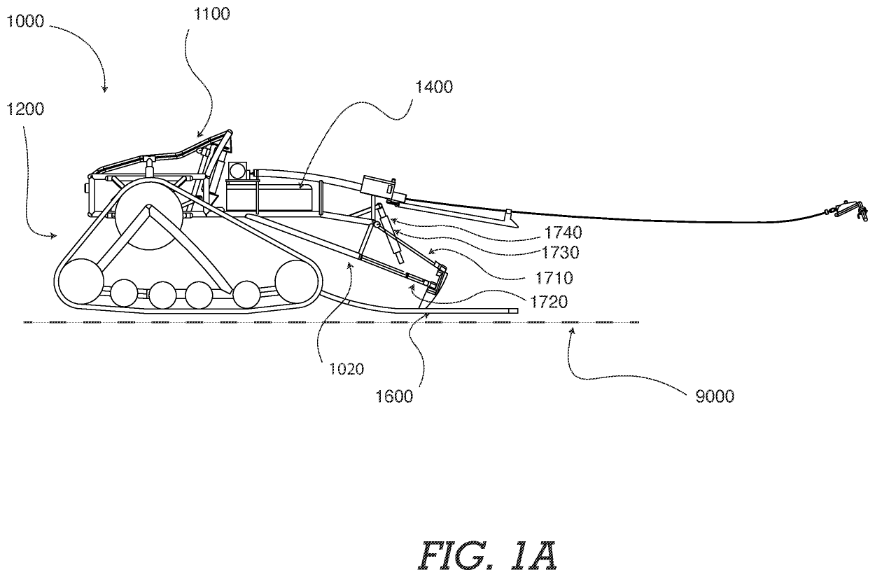

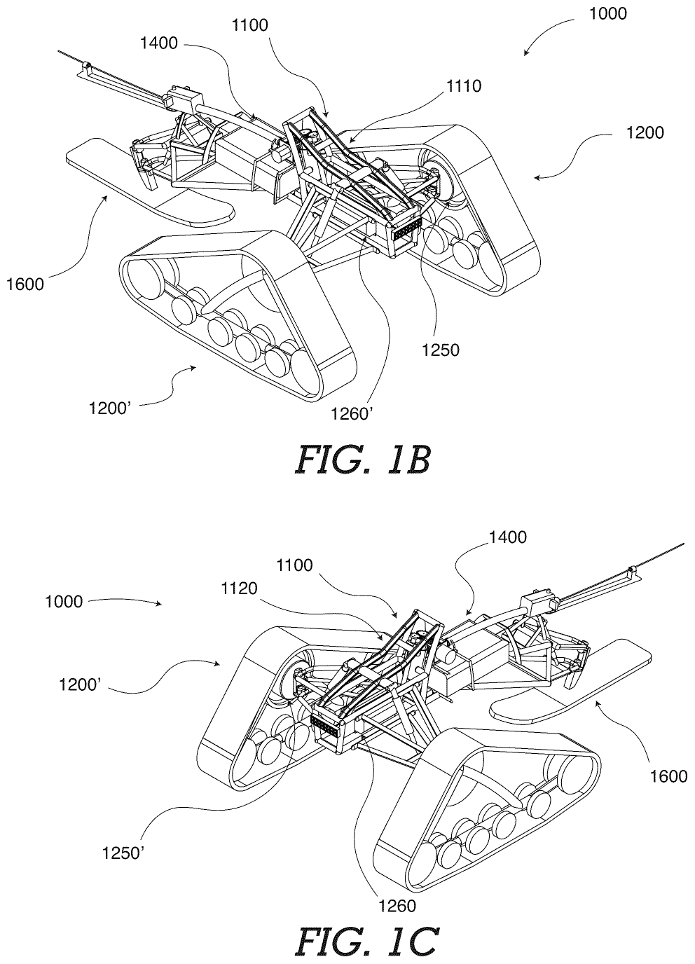

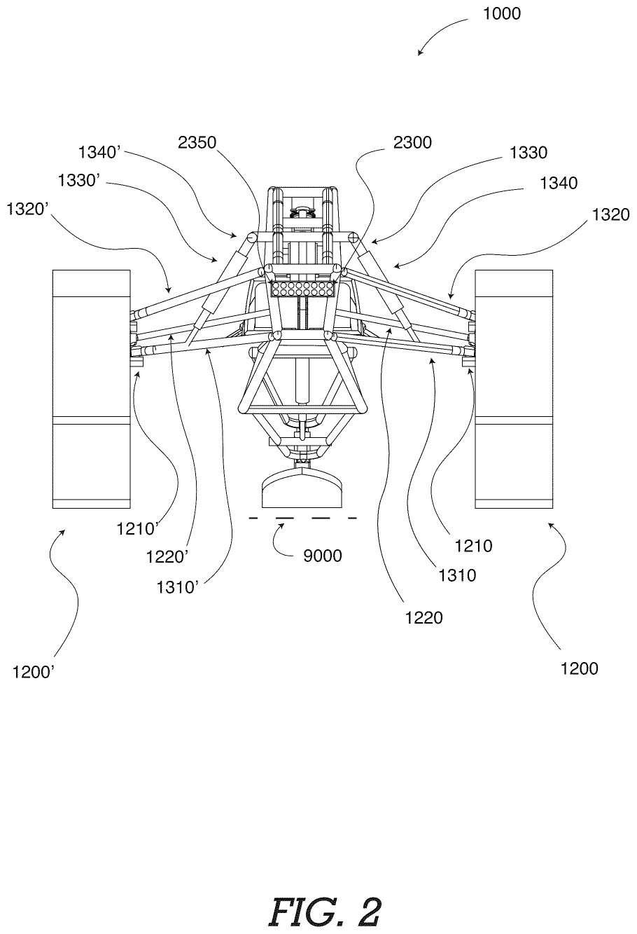

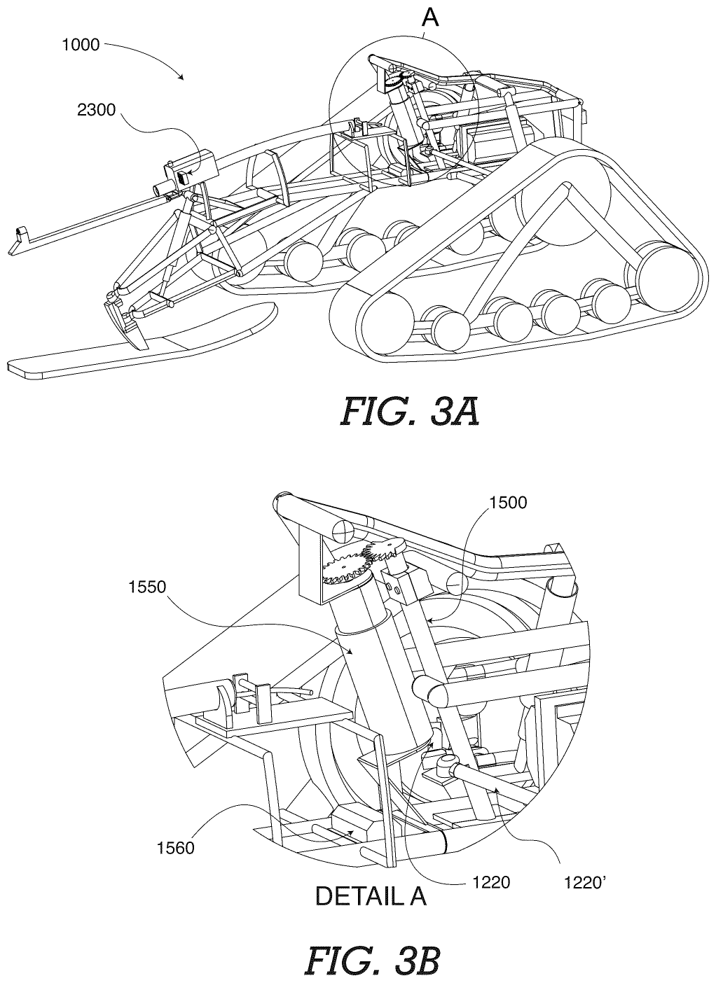

Certain embodiments of the present disclosure, as shown in FIG. 1A-FIG. 3B for instance, comprise a remotely controlled tracked vehicle 1000, also referred to herein as “vehicle apparatus”, wherein the vehicle comprises a frame 1100 configured to serve as a central mounting structure for the components of the vehicle. While embodiments of a frame 1100 as shown comprise a tubular metal construction, alternative frame construction materials and strategies such as hydroforming of aluminum, carbon fiber, aramid, and fiberglass are within the spirit and scope of the present disclosure. The vehicle further comprises a first driven track assembly 1200 interconnected to a first lateral side 1110 of the frame, and a second driven track assembly 1200′ interconnected to a second lateral side 1120 of the frame. The driven track assemblies as shown are interconnected with the frame 1100 with a suspension 1300 therebetween to allow improved traction and travel over terrain. The suspension as shown comprises an upper control arm 1310, a lower control arm 1320, a spring 1330, and a damping device 1340. As shown the spring 1330 and damping device 1340 are incorporated in a single unit. However, alternate suspension 1300 designs are within the spirit and scope of the present disclosure. Furthermore, alternate embodiments wherein the driven track assemblies 1200 are interconnected with the frame rigidly—that is the driven track assemblies 1200 are interconnected with the frame without a suspension—are within the spirit and scope of the present disclosure.

The driven track assemblies 1200 each comprise an electrically actuated hub motor 1250, commonly referred to as a direct-drive in-wheel motor. The hub motors 1250 are powered by a battery 1400 which is interconnected with the frame 1100. In certain embodiments the battery is based on a 12-volt system, while in certain embodiments the battery comprises a 72-volt system. Batteries or electrical systems based on these voltages and other voltages are within the spirit and scope of the present disclosure. In certain embodiments the hub motor 1250 of the first driven track assembly 1200 is controlled by a first motor controller 1260 which is interconnected between the battery 1400 and the hub motor 1250 of the first driven track assembly, and the hub motor 1250′ of the second driven track assembly is controlled by a second motor controller 1260′ which is interconnected between the battery 1400 and the hub motor 1250′ of the second driven track assembly. In certain embodiments the motor controllers 1260 comprise wireless communication protocol capabilities such as radio control, Bluetooth®, WiFi®, or other known wireless control capabilities known in the art. While embodiments shown comprise a battery 1400 for powering electrically driven hub motors, alternate power sources such as solar power, and fuel cell generated electrical power for powering electrically driven hub motors are within the spirit and scope of the present disclosure. Furthermore, while electrically powered hub motors 1250 are shown and desired in certain embodiments, alternate embodiments wherein the driven track assemblies 1200 are powered by direct mechanical connection to a central electrical motor, internal combustion engines, or other known modes of powered automation are within the spirit and scope of the present disclosure.

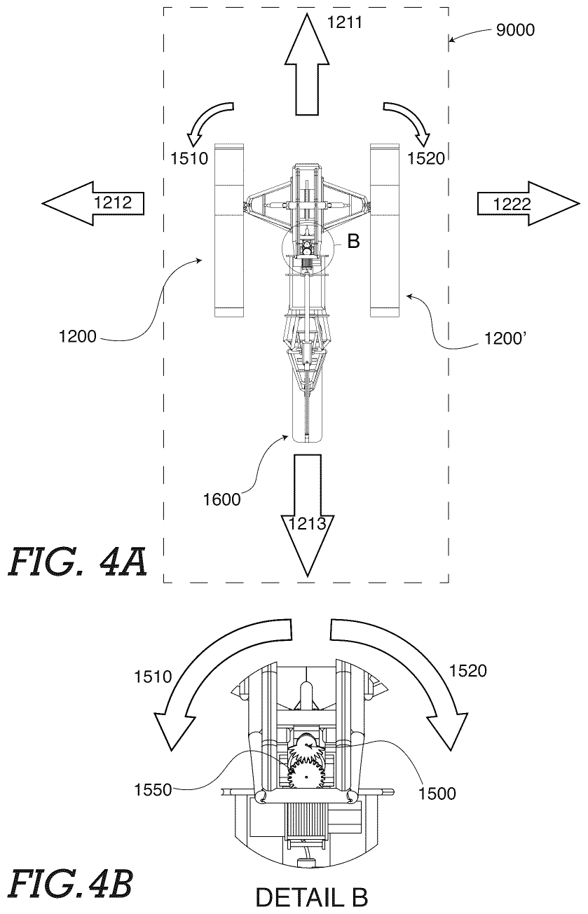

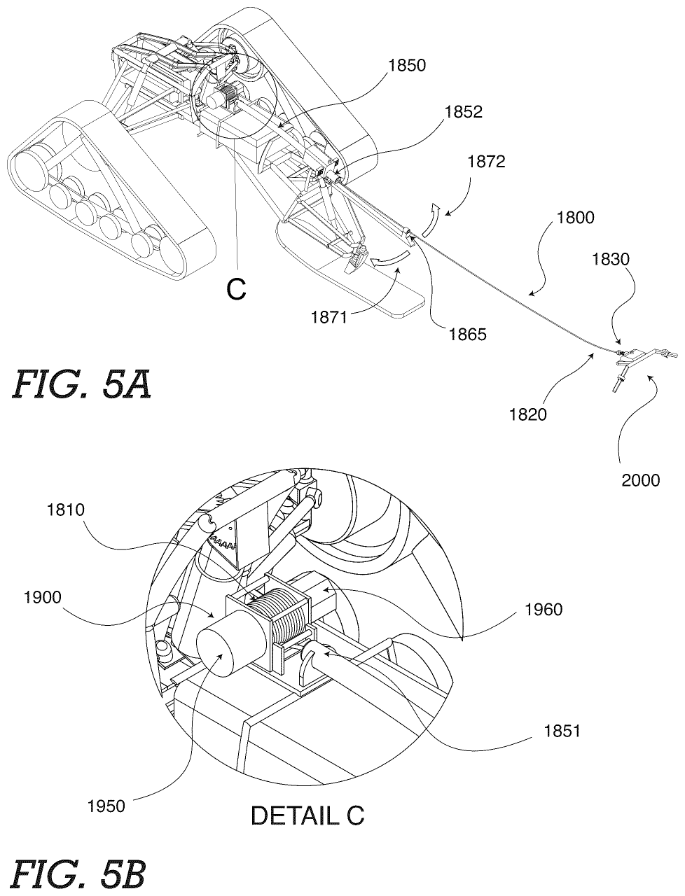

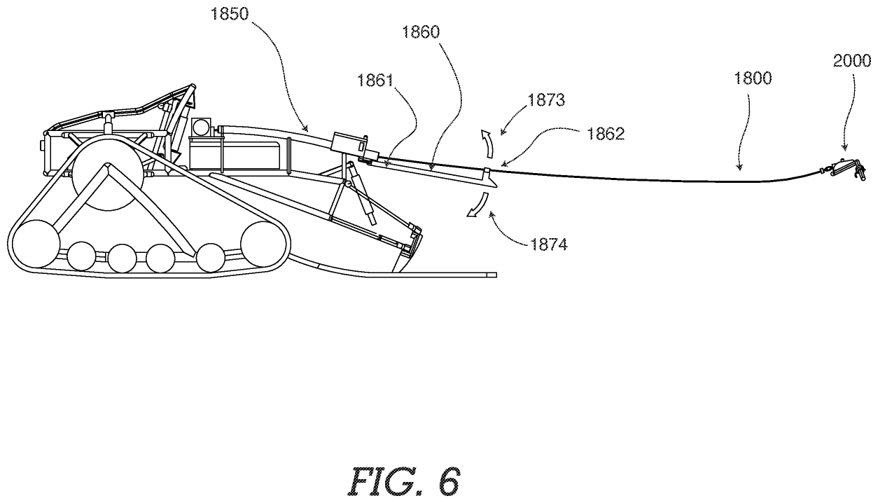

In certain embodiments, as shown in FIG. 4A-FIG. 6, the vehicle 1000 is steered through the use of a first steering knuckle 1210 interconnected with the first driven track assembly 1200 with a tie-rod 1220 and a second steering knuckle 1210′ interconnected to the second driven track assembly 1200′ with a tie-rod 1220′. The driven track assemblies 1200 are pivotally interconnected to the frame 1100 wherein the driven track assemblies are able to pivot rotatively in relation to a ground plane 9000, or ground surface, to allow the negotiation of turns. The steering knuckles 1210 each comprise a mechanical interconnection with a steering shaft 1500, such as with a tie-rod 1220, which controls the rotation of the driven track assemblies 1200. In certain embodiments the rotation of the steering shaft 1500 in a first direction 1510 causes the driven tack assemblies to rotate in a second direction 1520, and the rotation of the steering shaft 1500 in the second direction causes the driven track assemblies 1200 to rotate in the first direction 1510. However, configurations wherein the rotation of the steering shaft 1500 in the first direction 1510 results in the rotation of the driven track assemblies in the first direction 1510 thereby directing the vehicle toward a first lateral direction 1212, and wherein the rotation of the steering shaft 1500 in the second direction 1520 results in the rotation of the driven track assemblies 1200 in the second direction 1520 thereby directing the vehicle toward a second lateral direction 1222 are within the spirit and scope of the present disclosure. In certain embodiments a steering motor 1550, comprising an electrical motor, is interconnected with the steering shaft 1500 wherein the steering motor 1550 is adapted for rotating the steering shaft in the first direction 1510 or the second direction 1520. The steering motor is powered by a battery 1400, and certain embodiments further comprise a steering motor controller 1560 which is interconnected between the battery 1400 and steering motor 1550. In certain embodiments the steering motor controller 1560 comprises wireless communication protocol capabilities such as radio control, Bluetooth®, WiFi®, or other known wireless control capabilities known in the art.

In certain embodiments, the steering of a remotely controlled tracked comprising a first driven track assembly 1200 and a second driven track assembly 1200′ comprises is accomplished through independent control of each of the driven track assemblies. To steer toward a first lateral direction 1212, the hub motor 1250 of the first driven track assembly is driven forward at a speed S₁ and the hub motor 1250′ of the second driven track assembly is driven forward at a speed S₂, wherein S₁<S₂. In order to steer toward the second lateral direction 1222, the hub motor 1250 of the hub motor 1250 of the first driven track assembly is driven forward at a speed S₁ and the hub motor 1250′ of the second driven track assembly is driven forward at a speed S₂, wherein S₁>S₂. In order to navigate tight turns the differential between the individual track speeds can be increased, while gradual turns require a lower differential between individual track speeds. Furthermore, to allow the rotation of the vehicle in place, it may be desired to drive the first track assembly 1200 in a forward direction 1211 and the second track assembly 1200′ in a rearward direction 1213, or drive the first track assembly 1200 in a rearward direction 1213 and the second track assembly 1200′ in a forward direction 1211.

In certain embodiments, as shown in FIG. 1A-FIG. 3B, a remotely controlled tracked vehicle comprises a ski 1600 adapted for sliding over snow and other winter terrain aspects wherein the ski 1600 is mounted to a rearward aspect 1020 of the frame and rearward of the driven track assemblies. In certain embodiments the interconnection of the ski 1600 to the frame comprises a suspension 1700. The suspension 1700 as shown comprises an upper control arm 1710, a lower control arm 1720, a spring 1730, and a damping device 1740. As shown the spring 1730 and damping device 1740 are incorporated in a single unit. Furthermore, alternate embodiments wherein the ski 1600 is interconnected with the frame rigidly—that is the ski 1600 is interconnected with the frame 1100 without a suspension—are within the spirit and scope of the present disclosure.

In certain embodiments, shown in FIG. 4A-FIG. 6 for instance, a tether 1800 comprises a first end 1810 interconnected with the vehicle and a second end 1820 adapted for being removably interconnected with the remote-controller 2000. In certain embodiments the first end 1810 of the tether is interconnected with the vehicle 1000 wherein the tether is retractable with a spooling device 1900, such as a winch or other mechanism to allow the retraction of the tether 1800 when not in use, or allow adjustment of the length of the tether. The second end 1820 of the tether comprises a connecting device 1830, such as a carabiner or spring-hook to allow the rapid interconnection and removal of the remote-controller 2000 from the second end 1820 of the tether. The connecting device 1830 of certain embodiments optionally comprises a quick-disconnect device which is optionally actuated by the user, and/or optionally actuated when certain criteria (e.g. in excess of a threshold force) are met to prevent injury to the user.

In certain embodiments, the vehicle comprises a winch 1900 which is actuated by a winch motor 1950 wherein the winch motor is powered by a battery 1400, and wherein the winch motor comprises an internal controller 1960 comprising wireless control capabilities. While embodiments described and shown herein comprise a winch motor comprising an internal controller 1960, embodiments wherein the motor controller of the winch motor 1950 is external or separate from the winch motor are within the spirit and scope of the present disclosure. In certain embodiments the winch motor 1950 comprises wireless communication protocol capabilities such as radio control, Bluetooth®, WiFi®, or other known wireless control capabilities known in the art.

In certain embodiments the tether 1800 passes through a tether housing 1850 wherein the tether housing is configured to direct the tether 1800 to the rearward aspect of the vehicle to prevent the tether 1800 from becoming entangled with the driven track assemblies 1200. Furthermore, in certain embodiments a pivoting guide arm 1860 provides further guidance to prevent the tether from entangling with parts of the vehicle such as the driven track assemblies 1200. In certain embodiments the guide arm 1860 comprises a first end 1861 pivotally interconnected with the rearward aspect 1852 of the tether housing which allows pivotal movement laterally in a first direction 1871 and a second direction 1872, as well as articulation upward 1873 and downward 1874 in relation to the rearward aspect of the tether housing 1850. The guide arm 1860 comprises an aperture 1865 at a second end 1862 which is configured to guide the tether toward the second end of the guide arm and the rearward aspect of the tether housing.

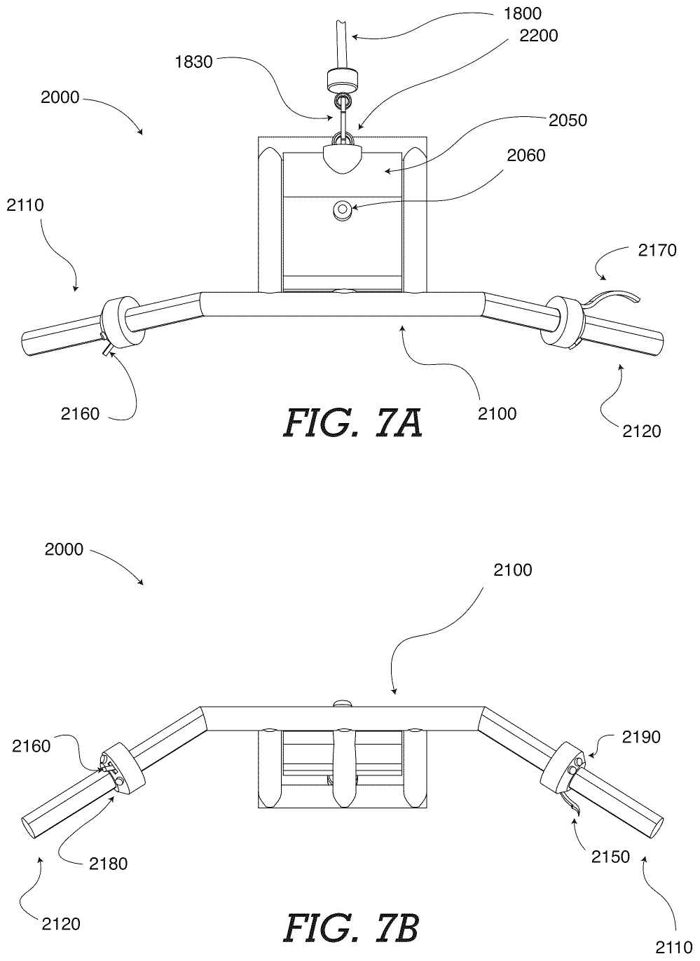

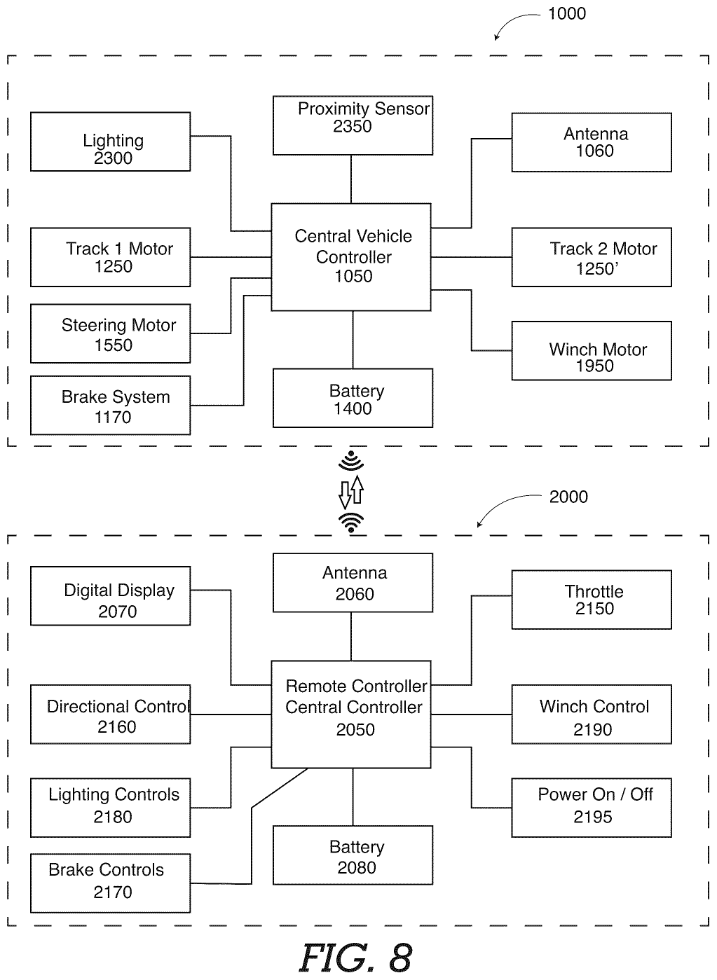

In certain embodiments, as shown in FIG. 7A-FIG. 8, a remote-controller 2000 is configured to communicate wirelessly with at least one motor controller unit, and preferably all motor controller units aboard the vehicle 1000 through wireless communication with a controller unit 2050 comprising an antenna 2060. In certain embodiments the remote-controller 2000 is configured to communicate with the first motor controller 1250 of the first driven track assembly, the second motor 1250′ controller of the second driven track assembly, and the steering motor controller 1560, and the winch motor controller 1960. In certain embodiments the remote-controller 2000 is configured to actuate a braking system 1070 directly through a brake motor controller or through the central controller 1050 as necessary. In certain embodiments the communication with motor controllers is done directly within a controller of each individual motor, while in alternate embodiments the remote-controller communicates through a central vehicle controller 1050 or CPU. The remote-control unit of certain embodiments comprises handlebars 2100 having a first lateral handle 2110 at a first distal end and a second lateral handle 2120 at a second distal end. The remote-controller 2000 provides throttle control 2150 and steering control 2160 allowing a user to pilot the vehicle at a distance. In certain embodiments the remote-controller comprises a tethering point 2200, or interconnection point, wherein a tether 1800 can be interconnected, using a connecting device 1830, between the vehicle and the remote-controller to allow a user to pilot the vehicle simultaneously while being towed by the vehicle. In certain embodiments the remote-controller 2000 comprises steering controls 2160, throttle 2150 or speed control, brake control 2170, lighting controls 2180, power on/off 2195, and winch controls 2190. In certain embodiments the throttle 2150 comprises a thumb actuated lever similar to those found on a common All-Terrain Vehicle (ATV) or snowmobile. In certain embodiments, the steering controls 2160 comprise a single axis joystick or rocker switch for controlling the steering of the vehicle. In certain embodiments, the remote-controller 2000 further comprises a display 2070 for communicating information to the user.

In certain embodiments, a vehicle as presented further comprises lighting elements 2300 for low-light visibility, as well as sensors such as proximity sensors 2350 which are used to prevent the collision of the vehicle with obstacles such as rocks, trees, and skiers. In certain embodiments a proximity sensor 2350 May be used in conjunction with an autonomous mode wherein the vehicle is programmed to follow a skier, return to a set way-point, or return to the user. A proximity sensor 2350 as presented can be interconnected with the motor controllers wherein the proximity sensor 2350 prevents further forward motion to prevent a collision. In such a mode, a user can use the remote-controller to further guide the vehicle or to override a sensor reading.

While certain embodiments described and shown comprise individual controllers for each of the plurality of motors, alternate embodiments, as shown in diagrammatic view shown in FIG. 8 comprise a central vehicle controller 1050 or Central Processing Unit (CPU) for the vehicle and a central controller CPU 2050 for the remote-controller. The vehicle CPU 1050 for the vehicle has shown comprises interconnections with an antenna 1060 aboard the vehicle for communicating with the remote-controller 2000, a battery 1400, the hub motor 1250 for the first driven track assembly, the hub motor 1250′ for the second driven track assembly, the steering motor 1550, and the winch motor 1950.

In certain embodiments, referencing FIG. 1B-FIG. 1C and FIG. 7A-FIG. 8 for instance, the braking of the vehicle is accomplished through regenerative braking systems which uses the hub motors 1250 to offer variable resistance to thereby slow the vehicle 1000 at variable rates as desired and convert kinetic energy to electrical energy which can be stored in the battery 1400. Alternate embodiments comprising conventional braking systems such as disc brakes or drum brakes are within the spirit and scope of the present disclosure. Such embodiments comprising conventional braking systems can be controlled wirelessly through the remote-controller 2000 wherein the brakes aboard the vehicle 1000 are actuated remotely through a mechanical, hydraulic, or electrically actuated brake system. Furthermore, certain embodiments of the present disclosure comprise an emergency brake system to allow a user to assure the vehicle 1000 does not move unintentionally when not in active use.

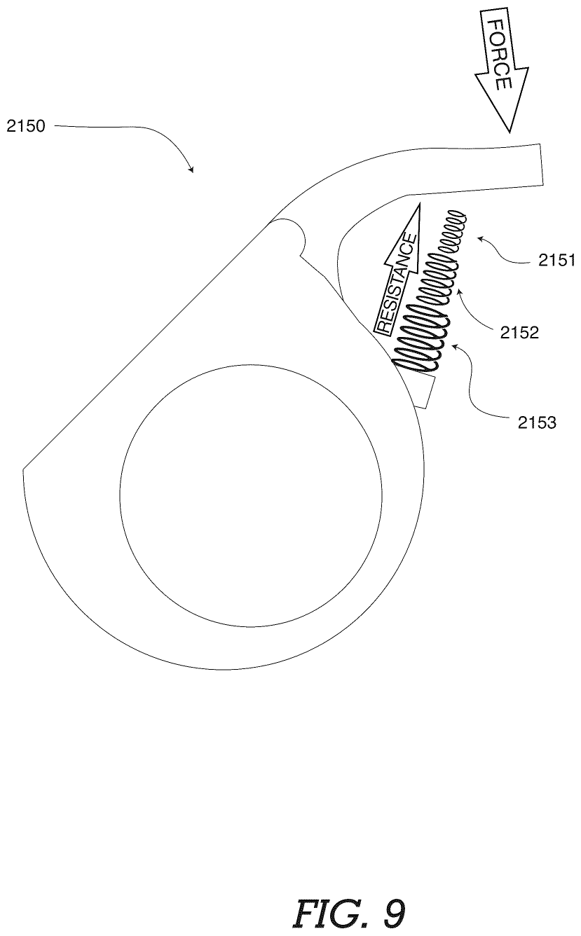

In certain embodiments, as shown in FIG. 9 for instance, a thumb throttle 2150 is configured to receive a progressive resistance to prevent the inadvertent or unintentional throttle increase, commonly referred to as a “blip” or “goosing” or the throttle wherein a sudden increase of throttle can result in loss of control of the vehicle apparatus. As represented in FIG. 9 for instance, a plurality of springs each with varying spring rates provide resistance against a force applied which acts to actuate the throttle. In certain embodiments a first spring 2151 with a first spring rate k₁ requires a first force threshold to actuate a first portion of throttle travel. A second spring 2152 with a second spring rate k₂, greater than the first spring rate, requires a second force threshold, greater than the first force threshold to actuate a second portion of throttle travel. Each relative portion of the throttle requires meeting the related force threshold to actuate the entirety of that particular portion of throttle travel. Further, in certain embodiments a third spring 2153 with a third spring rate k₃, greater than each of the first spring rate and the second spring rate, requires a third force which is greater than each of the first force and the second force to actuate a third portion of throttle travel. Embodiments which comprise a singular progressive spring with varying spring rates, springs used in parallel, springs used in series, coil springs, linear springs and other strategies used to provide a progressively greater spring rate over the travel of a rotational lever are within the spirit and scope of the present disclosure.

While various embodiments of the present disclosure have been described in detail, it is apparent that modifications and alterations of those embodiments will occur to those skilled in the art. However, it is to be expressly understood that such modifications and alterations are within the scope and spirit of the present disclosure. Further, the disclosures described herein are capable of other embodiments and of being practiced or of being carried out in various ways. In addition, it is to be understood that the phraseology and terminology used herein is for the purposes of description and should not be regarded as limiting. The use of “including,” “comprising,” or “adding” and variations thereof herein are meant to encompass the items listed thereafter and equivalents thereof, as well as, additional items.

What is claimed is:

1. A remotely controlled vehicle apparatus comprising:
a frame;
a battery interconnected to the frame;
a controller interconnected to the frame;
a tether interconnected to the frame;
a first driven track assembly interconnected to a first side of the frame wherein a first electrical motor is interconnected with the frame and configured to drive the first driven track assembly;
a second driven track assembly interconnected to a second side of the frame wherein a second electrical motor is interconnected with the frame and configured to drive the second driven track assembly;
a second electrical motor interconnected with the frame, wherein the second electrical motor is configured to drive the second driven track assembly;
a ski interconnected to the frame, wherein the ski is configured to contact a ground surface laterally between the driven track assemblies;
a remote-control configured to wirelessly communicate with the controller, wherein the remote-control is configured to control the driven track assemblies; and
the remote-control comprising a first handle, and an interconnection point, wherein the tether is configured to be removably interconnected to the interconnection point.

2. The vehicle apparatus of claim 1, wherein the first electrical motor and the second electrical motor are independently controlled by the remote-control.

3. The vehicle apparatus of claim 1, wherein interconnections between the driven track assemblies and the frame each comprise a track assembly suspension.

4. The vehicle apparatus of claim 3, wherein the interconnection between the ski and the frame comprises a ski suspension.

5. The vehicle apparatus of claim 3, further comprising a steering mechanism comprising an electrical motor configured to direct the driven track assemblies,
wherein rotation of the electrical motor in a first direction results in steering of the vehicle apparatus toward a first lateral direction, and wherein rotation of the electrical motor in a second direction results in steering of the vehicle apparatus toward a second lateral direction.

6. The vehicle apparatus of claim 1, wherein the remote-control comprises a second handle, wherein the first handle and the second handle are distally located from each other, and wherein the interconnection point is located between the first handle and the second handle.

7. The vehicle apparatus of claim 1, further comprising a proximity sensor interconnected to the vehicle apparatus, wherein the proximity sensor is interconnected with the controller; wherein the proximity is sensor directed in a forward direction in relation to vehicle apparatus.

8. The vehicle apparatus of claim 7, wherein the proximity sensor is interconnected to a forward aspect of the frame.

9. The vehicle apparatus of claim 1, wherein the ski is configured to contact the ground surface rearward of the driven track assemblies.

10. The vehicle apparatus of claim 1 further comprising a guide arm comprising a first end interconnected with a rearward aspect of the vehicle apparatus, wherein a second end of the guide arm extends in a rearward direction from the vehicle apparatus, and
wherein the guide arm is configured guide the tether rearward of the vehicle apparatus.

11. The vehicle apparatus of claim 10, wherein the guide arm is pivotally interconnected to the vehicle apparatus, wherein the guide arm is configured to pivot laterally in a first direction and a second direction.

12. The vehicle apparatus of claim 11, wherein the guide arm is further configured to articulate upward and downward.

13. The vehicle apparatus of claim 1 further comprising a spooling device configured to extend and retract the tether.

14. The vehicle apparatus of claim 13, wherein the spooling device comprises a winch.

15. The vehicle apparatus of claim 14, wherein the remote-control is configured to control at least one operation of the winch.

16. The vehicle apparatus of claim 1, wherein the remote-control is wirelessly interconnected with the controller of the vehicle apparatus.

17. The vehicle apparatus of claim 16, wherein the remote-control comprises steering controls, speed controls, brake controls, lighting controls, vehicle apparatus power control, and winch control.

18. The vehicle apparatus of claim 1, wherein the remote-control comprises a thumb actuated throttle; and
the thumb actuated throttle comprising a progressive spring rate wherein a first force threshold is required to actuate a first throttle portion, and a second force threshold is required to actuate a second throttle portion.

19. The vehicle apparatus of claim 18, wherein the progressive spring rate comprises a third force threshold to actuate a third throttle portion.

20. A remotely controlled tracked vehicle apparatus comprising:
a frame;
a battery interconnected to the frame;
a controller interconnected to the frame;
a retractable tether interconnected to the frame;
a proximity sensor interconnected to a forward aspect of the frame;
a first driven track assembly interconnected to a first side of the frame, wherein the interconnection between the first driven track assembly and the frame comprises a suspension;
a first electrical motor interconnected with the frame, wherein the first electrical motor is configured to drive the first driven track assembly;
a second driven track assembly interconnected to a second side of the frame, wherein the interconnection between the second driven track assembly and the frame comprises a suspension;
a second electrical motor interconnected with the frame, wherein the second electrical motor is configured to drive the second driven track assembly;
a ski interconnected to a rearward aspect of the frame, wherein the ski is rearward of the driven track assemblies, and wherein the interconnection between the ski and the frame comprises a suspension;
a steering mechanism comprising an electrical motor configured to direct the driven track assemblies, wherein rotation of the electrical motor in a first direction results in steering of the vehicle apparatus toward a first lateral direction, wherein rotation of the electrical motor in a second direction results in steering of the vehicle apparatus toward a second lateral direction;
a remote-control unit configured to wirelessly communicate with the controller to control the driven track assemblies, and the steering mechanism; and
the remote-control unit comprising a first lateral handle, a second lateral handle, and an interconnection point located therebetween,
wherein the retractable tether is configured to be removably interconnected to the interconnection point.
